(19) United States
(12) Patent Application Publication
(10) Pub. No.: US 2026/0264616 A1
(43) Pub. Date: Sep. 10, 2026

(54) FOLDING LADDERS FOR FLATBED TRAILERS AND TRUCKS

(71) Applicant: Hyundai Translead, San Diego, CA (US)

(72) Inventors: Manuel Medina Morales, Tijuana (MX); Joel Maldonado Contreras, Tijuana (MX)

(21) Appl. No.: 19/559,109

(22) Filed: Mar. 6, 2026

Related U.S. Application Data
(60) Provisional application No. 63/768,930, filed on Mar. 8, 2025.

(51) Int. Cl. B60R 3/02; E06C 1/34

(52) U.S. Cl. CPC B60R 3/02; E06C 1/34

(57) ABSTRACT

A storable ladder assembly configured to attach to an underside of a platform and transition between a stored state and a deployed state is provided. In one aspect, the storable ladder includes a pair of parallel side rails including slots and a support step between the side rails. The storable ladder also includes an upper step frame having a first end slidably coupled to the slots and configured to rest against the support step in the deployed state. The storable ladder also includes a lower step frame rotatably attached to the upper step frame and configured to rest against the stop in the deployed state.

### INCORPORATION BY REFERENCE TO ANY PRIORITY APPLICATIONS

This application claims the benefit of priority to U.S. Provisional Patent Application No. 63/768,930, entitled “FOLDING LADDERS FOR FLATBED TRAILERS,” filed on Mar. 8, 2025, which is hereby incorporated by reference in its entirety and for all purposes.

### FIELD

The present technology relates to a storable ladder assembly and methods of using a storable ladder assembly.

### DESCRIPTION OF THE RELATED ART

Ladders can aid in safely climbing onto and off of raised platforms. These ladders can be used across various industries to allow for safe access to raised platforms.

### SUMMARY

The embodiments disclosed herein each have several aspects, no single one of which is solely responsible for the present disclosure’s desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing systems and methods related to folding ladders.

In one aspect, a storable ladder assembly configured to attach to an underside of a platform and transition between a stored state and a deployed state is provided. The storable ladder assembly includes a first side rail including a first sheet and a first slot in the first sheet. The storable ladder assembly also includes a second side rail including a second sheet and a second slot in the second sheet, the second side rail spaced apart from and parallel to the first side rail. The storable ladder assembly also includes a support step between the first side rail and the second side rail. The storable ladder assembly also includes an upper step frame including a step, the upper step frame having a first end slidably coupled to the first slot and the second slot, the upper step frame configured to rest against the support step in the deployed state. The storable ladder assembly also includes a lower step frame including a step, the lower step frame rotatably attached to the upper step frame.

In some embodiments, the upper step frame further includes a second step, a first step side rail, a first stop at a second end of the upper step frame, a second step side rail, a second stop at a second end of the upper step frame, and a second step between the first step side rail and the second step side rail. The step of the upper step frame is between the first step side rail and the second step side rail. The lower step frame further includes a first step side rail, a second step side rail, and a second step between the first step side rail and the second step side rail. The step of the lower step frame is between the first step side rail and the second step side rail, and the lower step frame is configured to rest against the first stop and the second stop of the upper step frame in the deployed state.

In some embodiments, in the stored state, the upper step frame and the lower step frame rest against the support step.

In some embodiments, in the deployed state, the first stop and the second stop are positioned such that the first step side rail and the second step side rail of the lower step frame are parallel to the first step side rail and the second step side rail of the upper step frame.

In some embodiments, in the stored state, the first step side rail of the lower step frame is interior to the first step side rail of the upper step frame, and the second step side rail of the lower step frame is interior to the second step side rail of the upper step frame.

In some embodiments, in the stored state, the lower step frame is nested within the upper step frame.

In some embodiments, the support step includes an angled surface, and in the deployed state, the upper step frame rests against the angled surface.

In some embodiments, in the deployed state, an angle between the upper step frame and the first and second slots is between 40 and 90 degrees.

In some embodiments, the upper step frame further includes a latch, and in the stored state, the latch is interior to the support step and against an inward surface of the support step.

In some embodiments, the latch includes a lip configured to engage the support step in the stored state.

In some embodiments, the first side rail further includes a first flange perpendicular to the first sheet, and the second side rail further includes a second flange perpendicular to the second sheet.

In some embodiments, the first slot is angled relative to the first flange such that a second end of the first slot is spaced a greater distance from the first flange than a first end of the first slot.

In some embodiments, in the deployed state, the step of the upper step frame and the step of the lower step frame are parallel to the first and second flanges.

In another aspect, a storable ladder is provided. The storable ladder includes a first side rail including a first sheet and a first slot in the first sheet; and a second side rail including a second sheet and a second slot in the second sheet, the second side rail spaced apart from and parallel to the first side rail and the first slot parallel to the second slot. The storable ladder also includes a support step between the first side rail and the second side rail. The storable ladder also includes a first step frame including a step, the first step frame having a first end configured to reversibly slide and pivot in the first and second slots between the first side rail and the second side rail. The storable ladder also includes a second step frame including a step. The second step frame has a first end attached to a second end of the first step frame and is configured to reversibly pivot.

In some embodiments, the first step frame further includes a first step side rail, a second step side rail, and a stop at the second end of the first step frame, where the step is between the first step side rail and the second step side rail, and the second step frame further includes a first step side rail and a second step side rail, where the step is between the first step side rail and the second step side rail.

In some embodiments, the first step frame further includes a pivot handle adjacent to the stop.

In some embodiments, the first step frame further includes a handle attached to the step and facing towards the second end of the first step frame.

In some embodiments, the first side rail further includes a first flange perpendicular to the first sheet, where the second side rail further includes a second flange perpendicular to the second sheet.

In some embodiments, the first flange and the second flange are configured to attach to a trailer or truck.

In some embodiments, a first handlebar reversibly secured to the first side rail and a second handlebar reversibly secured to the second side rail.

In some embodiments, the first handlebar is configured to be stored in a first sheath coupled to the first side rail, and the second handlebar is configured to be stored in a second sheath coupled to the second side rail.

In one aspect a kit is provided. The kit includes a storable ladder, a first cuff configured to hold the first handlebar, and a second cuff configured to hold the second handlebar.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIGS. 1 and 2 illustrate views of an embodiment of a storable ladder assembly in a deployed state according to an embodiment of the present disclosure.

FIG. 3 illustrates a view of an embodiment of a storable ladder assembly in a stored state according to an embodiment of the present disclosure.

FIG. 4 illustrates a view of the storable ladder assembly illustrated in FIG. 3 with handlebars in a deployed position.

FIGS. 5 illustrates a detailed view of the storable ladder assembly illustrated in FIG. 3.

FIG. 6A-6C illustrate various views of an embodiment of a storable ladder assembly according to an embodiment of the present disclosure.

### DETAILED DESCRIPTION

The ladder assemblies described herein can be provided on a variety of platforms, such as vehicles or structures connected to vehicles. For example, ladders assemblies according to the present disclosure can be attached to a platform, such as but not limited to a flatbed of a trailer. Embodiments of the ladder assemblies according to the present disclosure can advantageously be compact, robust, and transitioned between stored and deployed configurations. Embodiments of the ladder assemblies according to the present disclosure can be advantageously retrofitted or installed on a side portion or a rear portion of a frame of a flatbed trailer with few or no modifications to the frame. Devices, systems, and methods described herein can improve the ease and safety of climbing onto a platform, such as a flatbed. Advantageously, embodiments of the ladder assembly and methods according to the present disclosure are configured to be attached to and storable under a frame of a flatbed of a truck or trailer without taking up storage capacity or surface area on an upper surface of the flatbed. The embodiments of the ladder assembly described herein may fit between the main beam of a flatbed and the side rub rail to provide efficient access to the side of a flatbed trailer. Advantageously, embodiments of the ladder assembly and methods according to the present disclosure can provide three-point contact for improved stability and safety.

Although embodiments of the present disclosure are described with reference to a ladder assembly provided on a flatbed of a truck or trailer, it will be understood that ladder assemblies according to the present disclosure can be suitably implemented on many different platforms, including but not limited to van trucks and truck bodies, storage containers, fixed structures such as stages, docks, decks, and vehicles (for example watercraft, recreational vehicles, trucks, and construction vehicles). It will also be understood that ladder assemblies according to the present disclosure need not be provided on a side of a vehicle and can be provided in any suitable location of a platform, for example, the rear or aft of a vehicle. It will also be understood that ladder assemblies according to the present disclosure need not be provided on or attached to a support member of a flatbed trailer and can be suitably provided on or attached to any suitable structure of a platform. In addition, throughout this disclosure, a component or structure may be described as attached to another component or structure, but it will be understood that various components of the ladder assembly according to embodiments of the present disclosure can be formed as monolithic or unitary structures.

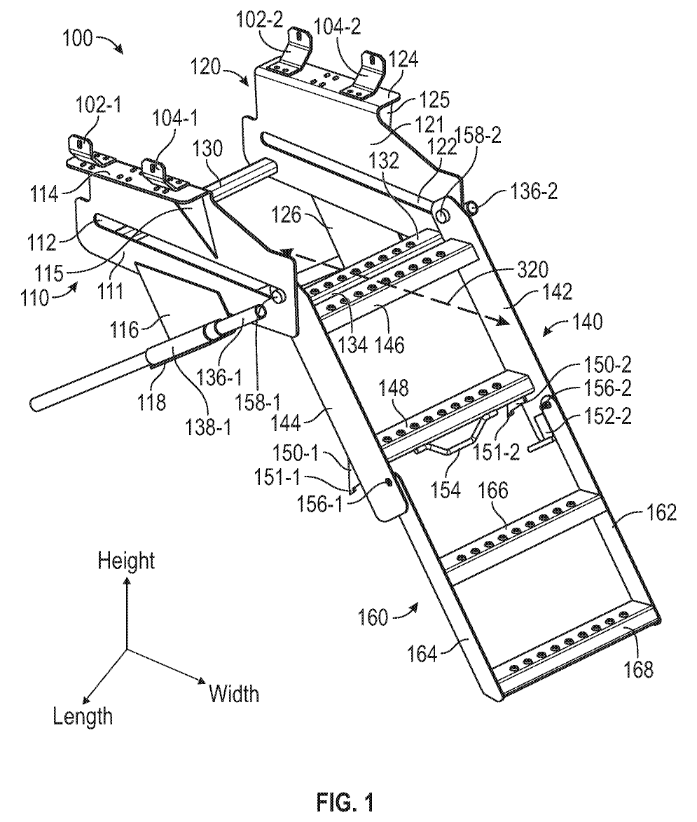

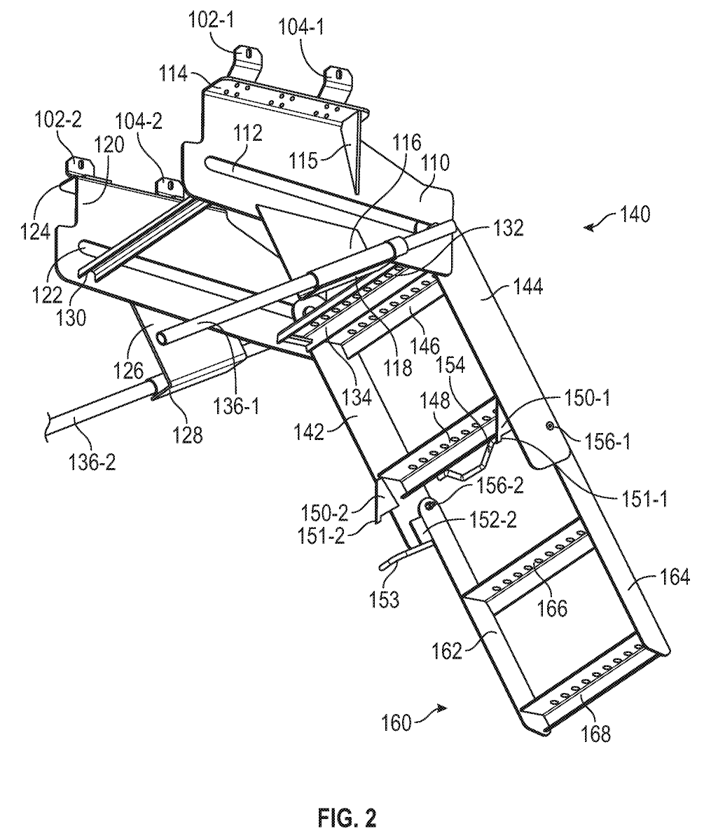

FIGS. 1 and 2 illustrate views of an example ladder assembly 100 according to an embodiment of the present disclosure. The ladder assembly 100 includes a latitudinal axis 320. The ladder assembly 100 can be transitioned between two states, a “deployed” state and a “stored” state. The ladder assembly 100 includes a first side rail 110, a second side rail 120, a support rail 130, a support step 132, an upper step frame 140, and a lower step frame 160. The ladder assembly 100 can optionally include a first sheath 138-1, a first handlebar 136-1, a second sheath 138-2, and a second handlebar 136-2. The upper step frame 140 can attach to the first side rail 110 and the second side rail 120. The upper step frame 140 can be slidably coupled to the first side rail 110 and the second side rail 120. The upper step frame 140 can slidably couple to the first side rail 110 and the second side rail 120 along slots or tracks described in detail below. The upper step frame 140 can be rotatably coupled to the first side rail 110 and the second side rail 120. The upper step frame 140 can rotatably couple to the first side rail 110 and the second side rail 120 at pivot points described in detail below. The upper step frame 140 can both slidably and rotatably attach to the first side rail 110 and the second side rail 120. The lower step frame 160 can couple to the upper step frame 140. The lower step frame 160 can rotatably couple to the upper step frame 140. The lower step frame 160 can rotatably attach to the upper step frame 140 at pivot points described in detail below.

The first side rail 110 can be spaced apart from the second side rail 120. The first side rail 110 can be parallel to the second side rail 120. The first side rail 110 and the second side rail 120 can attach to a vehicle or platform.

The first side rail 110 can include a sheet 111, a slot 112, and a flange 114. The first side rail 110 can be formed from sheet metal, for example, aluminum, steel, or another metal. The sheet 111 can be substantially planar. The sheet 111 can have a longer width than height. The slot 112 can be an opening or aperture through the sheet 111. The slot 112 can be a substantially rectangular opening in the sheet 111. The substantially rectangular opening can have rounded corners. The slot 112 can extend widthwise through a portion of the width of the sheet 111. The slot 112 can extend widthwise through the majority of the width of the sheet. The slot 112 can be angled relative to the flange 114 such that a second end of the slot 112 is spaced a greater distance from the flange 114 than a first end of the slot 112. The slot 112 can be at an angle of 0 degrees, 1 degree, 2 degrees, 3 degrees, 4 degrees, 5 degrees, 6 degrees, 7 degrees, 8 degrees, 9 degrees, 10 degrees, or more, or any value within a range defined by any two of the preceding values, though in some embodiments other angles may be implemented.

The flange 114 can be perpendicular to the sheet 111. A gusset 115 can be positioned between the flange 114 and the sheet 111. The gusset 115 can be attached to the flange 114 and the sheet 111. The gusset 115 can be triangular. The gusset 115 can provide structural stability to the first side rail 110.

A first L-bracket 102-1 can attach to the flange 114. The first L-bracket 102-1 can attach to the flange 114 near a first end of the width of the first side rail 110. In some non-limiting examples, the first L-bracket 102-1 can bolt to the flange 114. In some non-limiting examples, the first L-bracket 102-1 can rivet to the flange 114. Other suitable attachment mechanisms can be suitably implemented. For example, the first L-bracket 102-1 can be welded to the flange 114. The first L-bracket 102-1 can be configured to attach the ladder assembly 100 to a flatbed trailer 200. In some non-limiting examples, the first L-bracket 102-1 can bolt to the flatbed trailer 200. In some non-limiting examples, the first L-bracket 102-1 can rivet to the flatbed trailer 200. Other suitable attachment mechanisms can be suitably implemented. For example, the first L-bracket 102-1 can be welded to the flatbed trailer 200.

A second L-bracket 104-1 can attach to the flange 114. The second L-bracket 104-1 can attach to the flange 114 near a second end of the width of the flange 114. In some non-limiting examples, the second L-bracket 104-1 can bolt to the flange 114. In some non-limiting examples, the second L-bracket 104-1 can rivet to the flange 114. Other suitable attachment mechanisms can be suitably implemented. For example, the second L-bracket 104-1 can be welded to the flange 114. The second L-bracket 104-1 can be configured to attach the ladder assembly 100 to the flatbed trailer 200. In some non-limiting examples, the second L-bracket 104-1 can bolt to the flatbed trailer 200. In some non-limiting examples, the second L-bracket 104-1 can rivet to the flatbed trailer 200. Other suitable attachment mechanisms can be suitably implemented. For example, the second L-bracket 104-1 can be welded to the flatbed trailer 200.

The second side rail 120 can include a sheet 121, a slot 122, and a flange 124. The second side rail 120 can be formed from sheet metal, for example, aluminum, steel, or another metal. The sheet 121 can be substantially planar. The sheet 121 can have a longer width than its height. The slot 122 can be an opening or aperture through the sheet 121. The slot 122 can be a substantially rectangular opening in the sheet 121. The substantially rectangular opening can have rounded corners. The slot 122 can extend widthwise through a portion of the width of the sheet 121. The slot 122 can extend widthwise through the majority of the width of the sheet. The slot 122 can be angled relative to the flange 124 such that a second end of the slot 122 is spaced a greater distance from the flange 124 than a first end of the slot 122. The slot 122 can be at an angle of 0 degrees, 1 degree, 2 degrees, 3 degrees, 4 degrees, 5 degrees, 6 degrees, 7 degrees, 8 degrees, 9 degrees, 10 degrees, or more, or any value within a range defined by any two of the preceding values, though in some embodiments other angles may be implemented. The slot 122 can be parallel to the slot 112. The slot 122 can have substantially the same length as the slot 112.

The flange 124 can be perpendicular to the sheet 121. The flange 124 can be substantially parallel to the flange 114. The flange 124 can be substantially planar with the flange 114. A gusset 125 can be positioned between the flange 124 and the sheet 121. The gusset 125 can be attached to the flange 124 and to the sheet 121. The gusset 125 can be triangular. The gusset 125 can provide structural stability to the second side rail 120.

A first L-bracket 102-2 can attach to the flange 124. The first L-bracket 102-2 can attach to the flange 124 near a first end of the width of the side rail 120. In some non-limiting examples, the first L-bracket 102-2 can bolt to the flange 124. In some non-limiting examples, the first L-bracket 102-2 can rivet to the flange 124. Other suitable attachment mechanisms can be suitably implemented. For example, the first L-bracket 102-2 can be welded to the flange 114. The first L-bracket 102-2 can be configured to attach the ladder assembly 100 to the flatbed trailer 200. In some non-limiting examples, the first L-bracket 102-2 can bolt to the flatbed trailer 200. In some non-limiting examples, the first L-bracket 102-2 can rivet to the flatbed trailer 200. Other suitable attachment mechanisms can be suitably implemented. For example, the first L-bracket 102-2 can be welded to the flatbed trailer 200.

A second L-bracket 104-2 can attach to the flange 124. The second L-bracket 104-2 can attach to the flange 124 near a second end of the width of the flange 124. In some non-limiting examples, the second L-bracket 104-2 can bolt to the flange 124. In some non-limiting examples, the second L-bracket 104-2 can rivet to the flange 124. Other suitable attachment mechanisms can be suitably implemented. For example, the second L-bracket 104-2 can be welded to the flange 114. The second L-bracket 104-2 can be configured to attach the ladder assembly 100 to the flatbed trailer 200. In some non-limiting examples, the second L-bracket 104-2 can bolt to the flatbed trailer 200. In some non-limiting examples, the second L-bracket 104-2 can rivet to the flatbed trailer 200. Other suitable attachment mechanisms can be suitably implemented. For example, the second L-bracket 104-2 can be welded to the flatbed trailer 200.

A support rail 130 can be provided between the first side rail 110 and the second side rail 120. The support rail 130 can attach to the first side rail 110 to the second side rail 120. The support rail 130 can space the first side rail 110 a distance apart from the second side rail 120. The support rail 130 can be positioned below the slots 112 and 122. The support rail 130 can be positioned closer to the first end of the first side rail 110 and the first end of the second side rail 120. The support rail 130 can have a C-shaped profile. Other profiles can be suitably implemented. For example, the support rail 130 can have a flat, rectangular, I-shaped, or L-shaped profile.

A support step 132 can be provided between the first side rail 110 and the second side rail 120. The support step 132 can attach to the first side rail 110 to the second side rail 120. The support step 132 can space the first side rail 110 a distance apart from the second side rail 120. The support step 132 can be substantially parallel to the support rail 130. The support step 132 can be positioned below the slots 112 and 122. The support step 132 can be positioned closer to the second end of the first side rail 110 and the second end of the second side rail 120. The support step 132 can have a C-shaped profile. The C-shaped profile can include an angled surface 134 on the face of the C-shaped profile closest to the second end of the first side rail 110 and second side rail 120. Other profiles can be suitably implemented. For example, the support rail 130 can have a flat, rectangular, I-shaped, or L-shaped profile.

The upper step frame 140 can include a first step side rail 144, a second step side rail 142, a first step 146, a second step 148, a handle 154, a first slider 158-1, a second slider 158-2, a first latch 150-1, a second latch 150-2, a pivot handle 153, a first stop 152-1, and a second stop 152-2. As described above, the upper step frame 140 can be slidably and rotatably coupled to the first side rail 110 and the second side rail 120. The upper step frame 140 can slidably couple to the slot 112 of the first side rail 110. The upper step frame 140 can slidably couple to the slot 122 of the second side rail 120. The first slider 158-1 can be a post or strut having a circular cross-section. The first slider 158-1 can slidably couple to the first side rail 110. The first slider 158-1 can attach to the slot 112 of the first side rail 110. The first slider 158-1 can pass through the slot 112 to rotatably and/or slidably connect the upper step frame 140 to the first side rail 110. The first slider 158-2 can be a post or strut having a circular cross-section. The first slider 158-1 can be configured to slide and rotate within the slot 112 of the first side rail 110. The second slider 158-2 can slidably couple to the second side rail 120. The second slider 158-2 can attach to the slot 122 of the second side rail 120. The second slider 158-2 can pass through the slot 122 to rotatably and/or slidably connect the upper step frame 140 to the second side rail 120. The second slider 158-1 can be configured to slide and rotate within the slot 122 of the second side rail 120. The upper step frame 140 can have a width such that when the first slider 158-1 is engaged with the slot 112 and the second slider 158-2 is engaged with the second slot 122, the upper step frame 140 is inhibited from disconnecting from the first side rail 110 and the second side rail 120.

The first step side rail 144 and the second step side rail 142 can be spaced a distance along a length of the upper step frame 140. The first step side rail 144 can be parallel to the second step side rail 142. The first slider 158-1 can be provided at a first end of the first step side rail 144. The second slider 158-2 can be provided at a first end of the second step side rail 142. The first slider 158-1 and the second slider 158-2 can be co-axial.

In some examples, in the deployed state, the first step side rail 144 and the second step side rail 142 can contact the support step 132. The first step side rail 144 and the second step side rail 142 can rest against the support step 132. The first step side rail 144 and the second step side rail 142 can rest against the angled surface 134 of the support step 132. In some examples, the angle of the angled surface 134 can define the angle of the upper step frame 140 relative to the slots 112 and 122 in the deployed position. In some examples, the distance between the support step 132 and the ends of the slots 112 and 122 at the second end of the first side rail 110 and the second side rail 120, respectively, can define a deployed angle of the upper step frame 140 relative to the slots 112 and 122. In some examples, the angle between the upper step frame 140 and the slots 112 and 122 in the deployed position can be, or be about 40 degrees, 45 degrees, 50 degrees, 55 degrees, 60 degrees, 65 degrees, 70 degrees, 75 degrees, 80 degrees, 85 degrees, or 90 degrees, or any value within a range defined by any two of the preceding values, though in some embodiments other angles may be implemented. In one non-limiting example, the angle between the upper step frame 140 and the slots 112 and 122 in the deployed position can be approximately 55 degrees. Advantageously, the support step 132 can prevent the upper step frame 140 from rotating more than the deployed angle relative to the slots 112 and 122, thereby securing the upper step frame 140 in the deployed position. Advantageously, the support step 132 can allow the upper step frame 140 to be reversibly rotated to an angle less than the deployed angle, in order to secure the upper step frame 140 to a stored position.

The first step 146 can be provided between the first step side rail 144 and the second step side rail 142. The first step 146 can be positioned adjacent to the first slider 158-1 and the second slider 158-2. The first step 146 can be positioned closer to the second end of the first step side rail 144 and the second step side rail 142 than the first slider 158-1 and the second slider 158-2, respectively. The first step 146 can have an L-shaped profile. Other profiles can be suitably implemented. For example, the first step 146 can have a flat, rectangular, I-shaped, or C-shaped profile. The first step 146 can include a flat surface that is substantially parallel to the flanges 114 and 124 when the upper step frame 140 is in the deployed position.

The second step 148 can be provided between the first step side rail 144 and the second step side rail 142. The second step 148 can be positioned between the first end and the second end of the first step side rail 144 and the second step side rail 142, respectively. The second step 148 can be positioned closer to the second end of the first step side rail 144 and the second step side rail 142 than the first step 146. The second step 148 can have a C-shaped profile. Other profiles can be suitably implemented. For example, the second step 148 can have a flat, rectangular, I-shaped, or L-shaped profile. The second step 148 can include a flat surface that is substantially parallel to the flanges 114 and 124 when the upper step frame 140 is in the deployed position. The handle 154 can couple to the second step 148. The handle 154 can attach to the second step 148 and face towards the second end of the upper step frame 140. In some examples, the handle 154 can be integral and monolithic with the second step 148. In some examples, the handle 154 can be attached to the second step 148 by bolts, rivets, or welding.

The first latch 150-1 can attach to the first step side rail 144. The first latch 150-1 can be positioned below the second step 148. The first latch 150-1 can include a lip 151-1. The second latch 150-2 can attach to the second step side rail 142. The second latch 150-2 can be positioned below the second step 148. The second latch 150-2 can include a lip 151-2. The first latch 150-1 and the second latch 150-2 can be provided in a location of the first step side rail 144 and the second step side rail 142, respectively, where a user stepping on the first step 146 and the second step 148 will not be exposed to or interact with the first latch 150-1 and the second latch 150-2 when the upper step frame 140 is in the deployed position.

The first stop 152-1 (not visible in FIGS. 1 and 2) can attach to the first step side rail 144. The first stop 152-1 can be positioned at the second end of the first step side rail 144. The first stop 152-1 can be a plate, a pin, a lip, a flange, or another shape configured to limit the rotation of the lower step frame 160 relative to the upper step frame 140. The second stop 152-2 can attach to the second step side rail 142. The second stop 152-2 can be positioned at the second end of the second step side rail 142. The second stop 152-2 can be a plate, a pin, a lip, a flange, or another shape configured to limit the rotation of the lower step frame 160 relative to the upper step frame 140. The pivot handle 153 can be positioned adjacent to the second stop 152-2. In some examples, the pivot handle 153 can be positioned adjacent to the first stop 152-1.

The lower step frame 160 can include a first step side rail 164, a second step side rail 162, a first step 166, and a second step 168. The lower step frame 160 can couple to the upper step frame 140. The lower step frame 160 can rotatably attach to the upper step frame 140 with a first fastener 156-1 and a second fastener 156-2. The lower step frame 160 can pivotally attach to the upper step frame 140 at a first end of the lower step frame 160. The first fastener 156-1 and the second fastener 156-2 can facilitate rotation of the lower step frame 160 relative to the upper step frame 140. The first step side rail 164 of the lower step frame 160 can pivotally attach to the first step side rail 144 of the upper step frame 140. The second step side rail 162 of the lower step frame 160 can pivotally attach to the second step side rail 142 of the upper step frame 140. The first step side rail 164 can be positioned interior to the first step side rail 144. The second step side rail 162 can be positioned interior to the second step side rail 142.

The first step side rail 164 and the second step side rail 162 can be spaced a distance along a length of the lower step frame 160. The first step side rail 164 can be parallel to the second step side rail 162. In some examples, in the deployed state, the first step side rail 164 can rest against the first stop 152-1. In some examples, in the deployed state, the second step side rail 162 can rest against the second stop 152-2. In some examples, the first stop 152-1 and the second stop 152-2 can be positioned such that the first step side rail 164 and second step side rail 162 will be parallel to the first step side rail 144 and the second step side rail 142 in the deployed state.

The first step 166 can be provided between the first step side rail 164 and the second step side rail 162. The first step 166 can be positioned between the first end and the second end of the first step side rail 164 and the second step side rail 162, respectively. The first step 166 can have an L-shaped profile. Other profiles can be suitably implemented. For example, the first step 166 can have a flat, rectangular, I-shaped, or C-shaped profile. The first step 166 can include a flat surface which, in the deployed position, is substantially parallel to the flanges 114 and 124.

The second step 168 can be positioned between the first step side rail 164 and the second step side rail 162. The second step 168 can be positioned between the first end and the second end of the first step side rail 164 and the second step side rail 162. The second step 168 can be adjacent to the second end of the first step side rail 164 and the second step side rail 162. The second step 168 can have a C-shaped profile. Other profiles can be suitably implemented. For example, the second step 168 can have a flat, rectangular, I-shaped, or L-shaped profile. The second step 168 can include a flat surface which, in the deployed position, is substantially parallel to the flanges 114 and 124. Advantageously, the stops 152-1 and 152-2 can prevent the lower step frame 160 from rotating more than the deployed angle relative to the slots 112 and 122, thereby securing the lower step frame 160 in the deployed position. Advantageously, the stops 152-1 and 152-2 can allow the lower step frame 160 to be reversibly rotated to an angle less than the deployed angle, in order to nest the lower step frame 160 into the upper step frame 140.

A first handlebar 136-1 can be reversibly secured to the ladder assembly 100 at the first side rail 110. The first handlebar 136-1 can be a round bar. The first handlebar 136-1 can be reversibly positioned within a sheath 138-1. The sheath 138-1 can attach to the first side rail 110. The sheath 138-1 can attach to a sheath bracket 116 including a flange 118. The flange 118 can be positioned under the sheath 138-1. The sheath 138-1 can be coupled to the flange 118 by any suitable means, including but not limited to welding or mechanical fastener(s). The sheath bracket 116 can attach to the first side rail 110. The sheath bracket 116 can be coupled to the first side rail 110 by any suitable means, including but not limited to welding or mechanical fastener(s). The sheath 138-1 can be positioned at an angle relative to the flange 114 of the first side rail 110. The angle of the sheath 138-1 can advantageously secure the first handlebar 136-1 in a stored arrangement via gravity. The angle of the sheath 138-1 can advantageously cause the first handlebar 136-1 to be stored in an orientation and position that will not interfere with or obstruct other components of the flatbed trailer 200, such as a main beam, a side surface, or a side rub rail of the trailer.

A second handlebar 136-2 can be reversibly secured to the ladder assembly 100 at the second side rail 120. The second handlebar 136-2 can be a round bar. The second handlebar 136-2 can be reversibly positioned within a sheath 138-2. The sheath 138-2 can attach to the second side rail 120. The sheath 138-2 can attach to a sheath bracket 126 including a flange 128. The flange 128 can be positioned under the sheath 138-2. The sheath 138-2 can be coupled to the flange 118 by any suitable means, including but not limited to welding or mechanical fastener(s). The sheath bracket 126 can attach to the second side rail 120. The sheath bracket 126 can be coupled to the second side rail 120 by any suitable means, including but not limited to welding or mechanical fastener(s). The sheath 138-2 can be positioned at an angle relative to the flange 124 of the second side rail 120. The angle of the sheath 138-2 can advantageously secure the second handlebar 136-2 in a stored arrangement via gravity. The angle of the sheath 138-2 can advantageously cause the second handlebar 136-2 to be stored in an orientation and position that will not interfere with or obstruct other components of the flatbed trailer 200, such as a main beam, a side surface, or a side rub rail of the trailer.

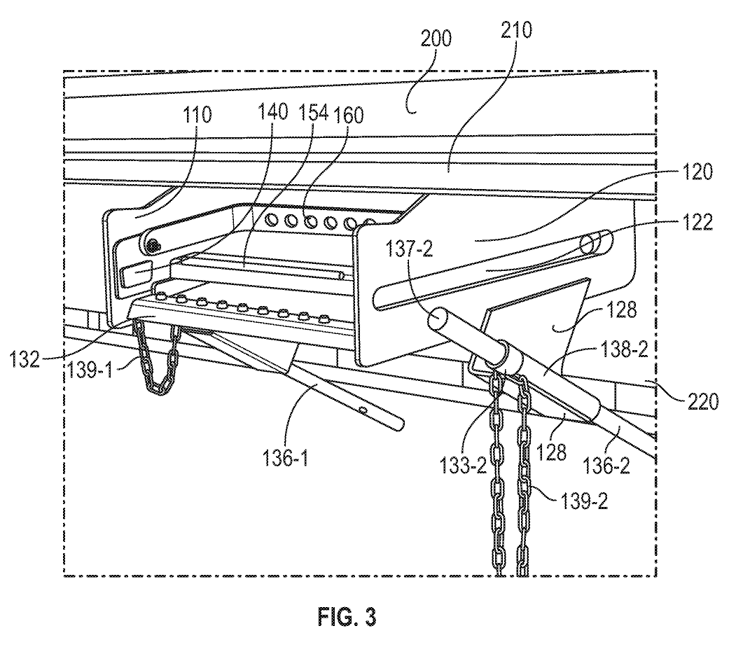

FIGS. 3-5 illustrate the ladder assembly 100 in a stored state. FIG. 3 illustrates an example of the ladder assembly 100 attached to a flatbed trailer 200 in a stored state according to an embodiment of the present disclosure. The flatbed trailer 200 includes a side surface 210. While reference to the side surface 210 of a flatbed trailer 200 is made herein in describing the location of the ladder assembly 100 and the components of the ladder assembly 100, it will be understood that the ladder assembly 100 can be positioned along other frame members of the flatbed trailer 200 or on a platform other than a flatbed, for example, a rear frame or a front frame. The ladder assembly 100 also includes a latitudinal axis 320. The side surface 210 can define a plane that is generally orthogonal to the latitudinal axis 320. The plane is oriented such that the flatbed trailer 200 is interior to the plane. Advantageously, in embodiments of the present disclosure, all components of the ladder assembly 100 can be positioned interior to the plane when the ladder assembly 100 is in the stored state.

As described above, the ladder assembly 100 can be transitioned between two states, a “deployed” state and a “stored” state. The ladder assembly 100 can include a first side rail 110 which attaches to the flatbed trailer 200, in this non-limiting embodiment to the underside of the flatbed trailer 200. The ladder assembly 100 can include a second side rail 120 which attaches to the flatbed trailer 200, in this non-limiting embodiment to the underside of the flatbed trailer 200. It will be understood that the first side rail 110 and the second side rail 120 can attach under a side rail of a vehicle anywhere support members are not present. The ladder assembly 100 can have a width such that the ladder assembly 100 can be positioned entirely between the plane defined by the side surface 210 of the flatbed trailer 200 and a plane defined by the main beam 220 of the flatbed trailer 200. The first side rail 110 and the second side rail 120 can each have a width such that the first side rail 110 and the second side rail 120 are positioned entirely between the plane defined by the side surface 210 of the flatbed trailer 200 and the plane defined by the main beam 220 of the flatbed trailer 200. The L-brackets 102-1, 102-2, 104-1, and 104-2 can attach to the underside of the flatbed trailer 200. The L-brackets 102-1, 102-2, 104-1, and 104-2 can attach to the underside of the flatbed trailer 200 exterior to a main beam 220 of the flatbed trailer 200. The first side rail 110 can include a first end and a second end. The second side rail 120 can include a first end and a second end. The first end of the first side rail 110 can align with the first end of the second side rail 120 and the second end of the first side rail 110 can align with the second end of the second side rail 120. When attached to the flatbed trailer 200, the second ends of the side rails 110 and 120 can positioned to be coincident with or touch the plane defined by the side surface 210 or they may be positioned interior to the plane. The first ends of the side rails 110 and 120 can be positioned interior to the plane defined by the side surface 210.

In the stored state, the upper step frame 140 can be nested between the first side rail 110 and the second side rail 120. In the stored state, the first step side rail 144 and the second step side rail 142 of the upper step frame 140 can form a plane which is parallel to a plane formed by the slot 112 and the slot 122. The first step side rail 144 and the second step side rail 142 can be positioned parallel to the slot 112 and the slot 122 of the first side rail 110 and the second side rail 120, respectively. In the stored state, the first step side rail 144 can be positioned interior to the sheet 111 and the second step side rail 142 can be positioned interior to the sheet 121. In the stored state, the lower step frame 160 can be nested within the upper step frame 140. In the stored state, the first step side rail 164 and the second step side rail 162 of the lower frame 160 can form a plane which is parallel to a plane formed by the first step side rail 144 and the second step side rail 142. The first step side rail 164 and the second step side rail 162 of the lower frame 160 can be positioned parallel to the first step side rail 144 and the second step side rail 142, respectively. In the stored state, first step side rail 164 can be positioned interior to the first step side rail 144 and the second step side rail 162 can be positioned interior to second step side rail 142.

In the stored state, substantially all of the ladder assembly 100 can be positioned interior to the plane defined by the side surface 210. The handle 154 can be positioned such that in the stored state, the handle 154 can be interior to the plane defined by the side surface 210. In the stored state, the first slider 158-1 can be positioned near the end of the slot 112 closest to the first end of the first side rail 110. For example, the first slider 158-1 can be positioned 0.5 inches, 0.75 inches, 1 inches, 1.25 inches, 1.5 inches, 1.75 inches, 2 inches, or more, or any value within a range defined by any two of the preceding values, away from the first end of the first side rail 110, though in some embodiments other lengths may be implemented. In the stored state, the second slider 158-2 can be positioned near the end of the slot 122 closest to the first end of the second side rail 120. For example, the second slider 158-2 can be positioned 0.5 inches, 0.75 inches, 1 inches, 1.25 inches, 1.5 inches, 1.75 inches, 2 inches, or more, or any value within a range defined by any two of the preceding values, away from the first end of the second side rail 120, though in some embodiments other lengths may be implemented.

The first handlebar 136-1 can include a stopper plug (not pictured) at one or both ends of the first handlebar 136-1. The second handlebar 136-2 can include a stopper plug 137-2 at one or both ends of the second handlebar 136-2. The stopper plugs can be made of rubber, plastic, aluminum, or another suitable material.

The first handlebar 136-1 can include a safety chain 139-1. The safety chain 139-1 can attach to the first handlebar 136-1 and the flange 118. In some non-limiting examples, the safety chain 139-1 can attach to the first handlebar 136-1 and the flatbed trailer 200. The safety chain 139-1 can attach to the first handlebar 136-1 with a cuff 133-1. The cuff 133-1 can be fixedly attached to the first handlebar 136-1. The cuff 133-1 can be positioned against the sheath 138-1 when the first handlebar 136-1 is stored in sheath 138-1. The cuff 133-1 can hold the first handlebar 136-1 in positioned relative to the sheath 138-1 when the first handlebar 136-1 is stored in the sheath 138-1. The cuff 133-1 can limit how far the first handlebar 136-1 can slide into the sheath 138-1 when the first handlebar 136-1 is stored in the sheath 138-1. The safety chain 139-1 can advantageously assure that the first handlebar 136-1 does not become disconnected from the flatbed trailer 200. In some non-limiting examples, the safety chain 139-1 can be a cable, a chain, or a rope.

The second handlebar 136-2 can include a safety chain 139-2. The safety chain 139-2 can attach to the second handlebar 136-2 and the flange 128. In some non-limiting examples, the safety chain 139-1 can attach to the first handlebar 136-1 and the flatbed trailer 200. The safety chain 139-2 can attach to the second handlebar 136-2 with a cuff 133-2. The cuff 133-2 can be fixedly attached to the second handlebar 136-2. The cuff 133-2 can be positioned against the sheath 138-2 when the second handlebar 136-2 is stored in sheath 138-2. The cuff 133-2 can hold the second handlebar 136-2 in positioned relative to the sheath 138-2 when the first handlebar 136-1 is stored in sheath 138-1. The cuff 133-2 can limit how far the second handlebar 136-2 can slide into the sheath 138-2 when the first handlebar 136-1 is stored in sheath 138-1. The safety chain 139-2 can advantageously assure that the second handlebar 136-2 does not become disconnected from the flatbed trailer 200. In some non-limiting examples, the safety chain 139-1 can be a cable, a chain, or a rope.

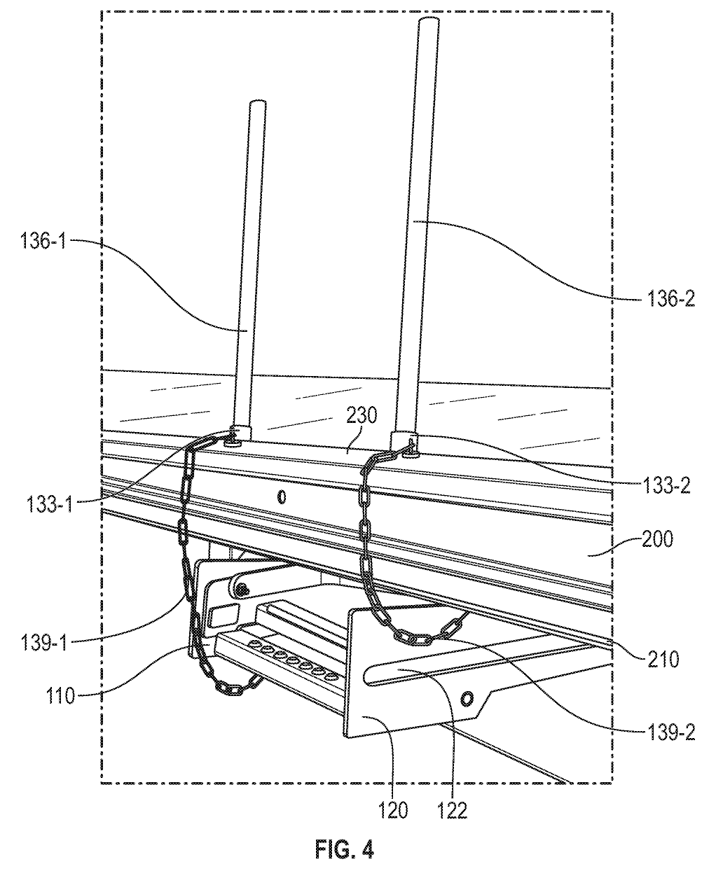

FIG. 4 illustrates the first handlebar 136-1 and the second handlebar 136-2 in a deployed state. In the deployed state, a first end of the first handlebar 136-1 can be attached to an aperture. The aperture can secure the first handlebar 136-1 in an upright position. Advantageously, when the first handlebar 136-1 is in the stowed state, there is no obstruction or ladder-related structure to impede movement of cargo or users on the deck of the flatbed trailer 200. The aperture can be positioned interior to the plane defined by the side surface 210. The aperture can be positioned in an upper surface 230 of the flatbed trailer 200. The aperture can be positioned substantially in line with the first side rail 110 in the lengthwise direction of the flatbed trailer 200. In some non-limiting examples, the aperture can be inset into the upper surface 230. The aperture can have a corresponding shape to the first handlebar 136-1 such that the first handlebar 136-1 can slide into the aperture. In some examples, the cuff 133-1 can be positioned against the aperture. The cuff 133-1 can hold the first handlebar 136-1 in positioned relative to the aperture. The cuff 133-1 can limit how far the first handlebar 136-1 can slide into the aperture. The safety chain 139-1 can have a length such that the first handlebar 136-1 can transition between the deployed state and the stored state without being inhibited by the safety chain 139-1.

In the deployed state, a first end of the second handlebar 136-2 can be attached to an aperture. The aperture can secure the second handlebar 136-2 in an upright position. Advantageously, when the second handlebar 136-2 is in the stowed state, there is no obstruction or ladder-related structure to impede movement of cargo or users on the deck of the flatbed trailer 200. The aperture can be positioned interior to the plane defined by the side surface 210. The aperture can be positioned on an upper surface 230 of the flatbed trailer 200. The aperture can be positioned substantially in line with the second side rail 120 in the lengthwise direction of the flatbed trailer 200. In some non-limiting examples, the aperture can be inset into the upper surface 230. In some non-limiting examples, the aperture can be mounted onto the upper surface 230. The aperture can have a corresponding shape to the second handlebar 136-2 such that the second handlebar 136-2 can slide into the aperture. In some examples, the cuff 133-2 can be positioned against the aperture. The cuff 133-2 can hold the second handlebar 136-2 in positioned relative to the aperture. The cuff 133-2 can limit how far the second handlebar 136-2 can slide into the aperture. The safety chain 139-2 can have a length such that the second handlebar 136-2 can transition between the deployed state and the stored state without being inhibited by the safety chain 139-2.

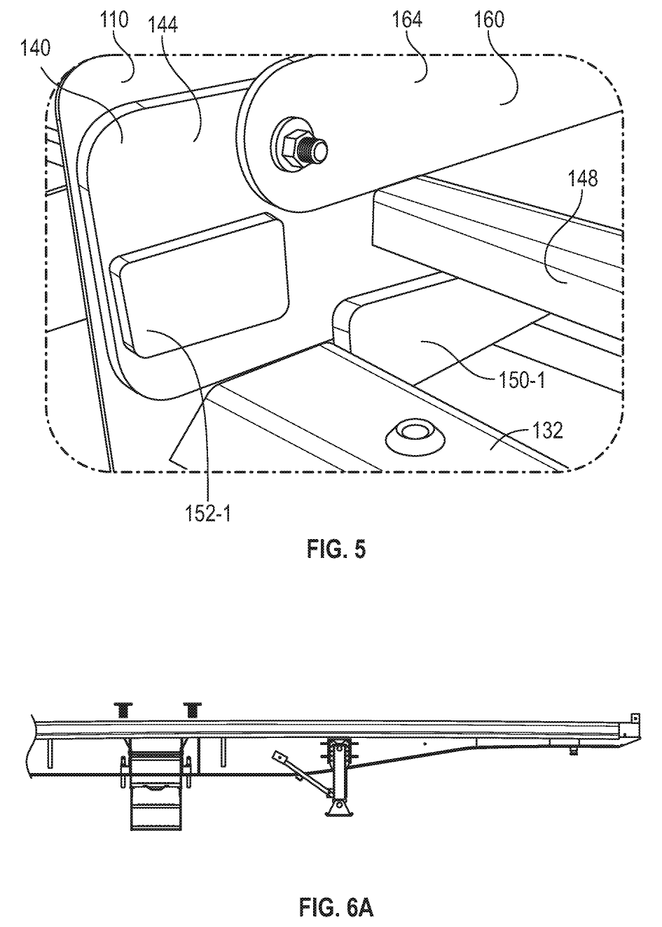

FIG. 5 is a detailed view showing a latching mechanism of the ladder assembly 100 in the stored state. The lower step frame 160 can rest on top of the upper step frame 140 when the ladder assembly 100 is in the stored state. The upper step frame 140 can rest against the support step 132 when the ladder assembly 100 is in the stored state. While the first side of the ladder assembly 100 including the first side rail 110 is illustrated, it will be understood that the second side of the ladder assembly 100 including the second side rail 120 can include substantially the same features as those described with regard to the first side. The first step side rail 164 of the lower step frame 160 can be positioned on top of the second step 148 of the upper step frame 140. The second step 148 can inhibit the lower step frame 160 from rotating past the stored state position. The second step 148 can support the lower step frame 160 in the stored position. In some examples, the first step 146 (not visible in FIG. 5) can also support the lower step frame 160. The first step side rail 164 can be positioned on top of the first step 146 and the second step 148.

In the stored state, the upper step frame 140 can be positioned with the first latch 150-1 positioned interior to the support step 132. The first latch 150-1 can be positioned against the inward surface of the support step 132. The first latch 150-1 can include a lip 151-1. In the stored state, the lip 151-1 can be positioned below the support step 132 while the first latch 150-1 is positioned against the inward surface of the support step 132. The lip 151-1 can require the upper step frame 140 to be pushed inward along the slots 112 and 122, then pulled upward, so that the latch 150-1 is positioned above the support step 132, then pulled outwards along the slots 112 and 122 into the deployed position. This order of operations for transitioning the ladder assembly 100 from the stored position to the deployed position can advantageously ensure that the ladder assembly 100 will remain in the stored position until the ladder assembly 100 is deployed by a user. Advantageously, this order of operations for transitioning the ladder assembly 100 from the stored position to the deployed position can ensure that the ladder assembly will remain in the stored position while the flatbed trailer 200 is moving. Additionally, the angle of the slots 112 and 122 relative to the flanges 114 and 124 can advantageously allow gravity to press the latches 150-1 and 150-2 against the support step 132 and engage the lips 151-1 and 151-2 below the support step 132.

To move between the stored state illustrated in FIGS. 1 and 2, and the deployed state illustrated in FIGS. 3, 4, and 5, the handle 154 can be pushed inward to disengage the lips 151-1 and 151-2 from the support step 132. The handle 154 can then be lifted to pivot the upper step frame 140 such that the latches 150-1 and 150-2 are positioned above the support step 132. Once the latches 150-1 and 150-2 are above the support step 132, the upper step frame 140 can be moved, for example pulled outward so that the upper step frame 140 and lower step frame 160 translate outward along the latitudinal axis 320. The first slider 158-1 and the second slider 158-2 can translate along the slots 112 and 122. Once the first slider 158-1 and the second slider 158-2 reach the second end of the slots 112 and 122, the handle 154 can be rotated downward to pivot the upper step frame 140, until the first step side rail 144 and second step side rail 142 are resting against the support step 132. The pivot handle 153 can be lifted to rotate the lower step frame 160, until the first step side rail 164 and the second step side rail 162 are resting against the first stop 152-1 and the second stop 152-2. To move between the deployed state and into the stored state, these steps may be performed in reverse order.

To move the handlebars 136-1 and 136-2 between the stored state illustrated in FIGS. 12 and 3, and the deployed state illustrated in FIG. 4, the first handlebar 136-1 can be pulled out of the sheath 138-1 and inserted into a first aperture. The second handlebar 136-2 can be pulled out of the sheath 138-2 and inserted into a second aperture. To move between the deployed state and into the stored state, these steps may be performed in reverse order.

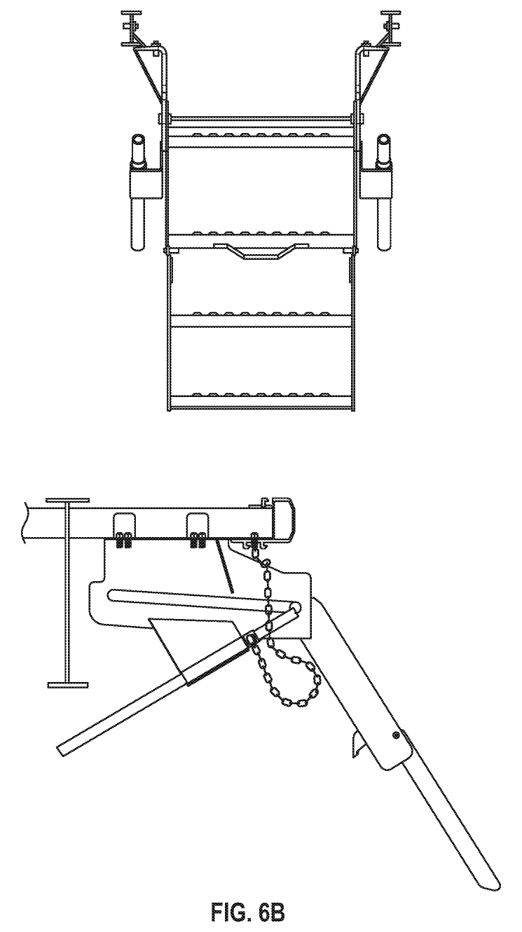

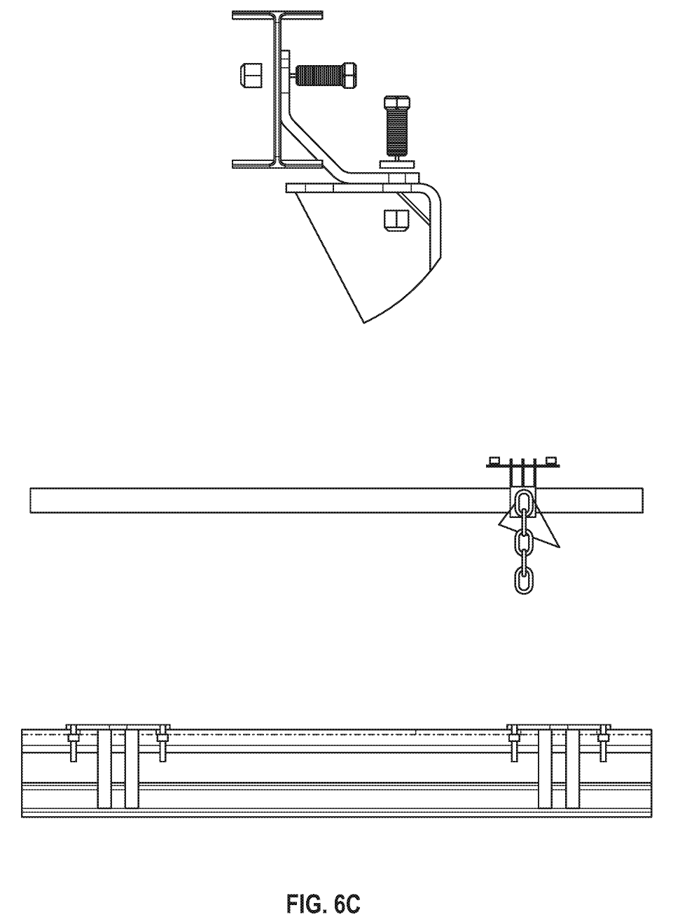

FIG. 6A-6C illustrate an example of a ladder assembly 100 showing top, side, and detailed section views of various components of the ladder assembly 100 according to an embodiment of the present disclosure.

The above-described embodiments have been provided by way of example, and the present invention is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present invention is not intended to be limited by the disclosed embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Embodiments presented herein are by way of example and not by way of limitation. The intent of the following detailed description, although discussing exemplary embodiments, is to be construed to cover all modifications, alternatives, and equivalents of the embodiments as may fall within the spirit and scope of the disclosure.

What is claimed is:

1. A storable ladder assembly configured to attach to an underside of a platform and transition between a stored state and a deployed state, the storable ladder assembly comprising:
a first side rail comprising a first sheet and a first slot in the first sheet;
a second side rail comprising a second sheet and a second slot in the second sheet, the second side rail spaced apart from and parallel to the first side rail;
a support step between the first side rail and the second side rail;
an upper step frame comprising a step, the upper step frame having a first end slidably coupled to the first slot and the second slot, the upper step frame configured to rest against the support step in the deployed state; and
a lower step frame comprising a step, the lower step frame rotatably attached to the upper step frame.

2. The storable ladder assembly of claim 1, wherein:
the upper step frame further comprises:
a second step;
a first step side rail;
a first stop at a second end of the upper step frame;
a second step side rail;
a second stop at a second end of the upper step frame; and
a second step between the first step side rail and the second step side rail, wherein the step of the upper step frame is between the first step side rail and the second step side rail; and
the lower step frame further comprises:
a first step side rail;
a second step side rail; and
a second step between the first step side rail and the second step side rail;
wherein the step of the lower step frame is between the first step side rail and the second step side rail, and wherein the lower step frame is configured to rest against the first stop and the second stop of the upper step frame in the deployed state.

3. The storable ladder assembly of claim 1, wherein in the stored state, the upper step frame and the lower step frame rest against the support step.

4. The storable ladder assembly of claim 2, wherein in the deployed state, the first stop and the second stop are positioned such that the first step side rail and the second step side rail of the lower step frame are parallel to the first step side rail and the second step side rail of the upper step frame.

5. The storable ladder assembly of claim 2, wherein in the stored state, the first step side rail of the lower step frame is interior to the first step side rail of the upper step frame, and the second step side rail of the lower step frame is interior to the second step side rail of the upper step frame.

6. The storable ladder assembly of claim 1, wherein in the stored state, the lower step frame is nested within the upper step frame.

7. The storable ladder assembly of claim 1, wherein the support step comprises an angled surface, and wherein in the deployed state, the upper step frame rests against the angled surface.

8. The storable ladder assembly of claim 1, wherein in the deployed state, an angle between the upper step frame and the first and second slots is between 40 and 90 degrees.

9. The storable ladder assembly of claim 1, wherein the upper step frame further comprises a latch, and wherein in the stored state, the latch is interior to the support step and against an inward surface of the support step.

10. The storable ladder assembly of claim 9, wherein the latch comprises a lip configured to engage the support step in the stored state.

11. The storable ladder assembly of claim 1, wherein the first side rail further comprises a first flange perpendicular to the first sheet, and wherein the second side rail further comprises a second flange perpendicular to the second sheet.

12. The storable ladder assembly of claim 11, wherein the first slot is angled relative to the first flange such that a second end of the first slot is spaced a greater distance from the first flange than a first end of the first slot.

13. The storable ladder assembly of claim 11, wherein in the deployed state, the step of the upper step frame and the step of the lower step frame are parallel to the first and second flanges.

14. A storable ladder comprising:
a first side rail comprising a first sheet and a first slot in the first sheet;
a second side rail comprising a second sheet and a second slot in the second sheet, the second side rail spaced apart from and parallel to the first side rail and the first slot parallel to the second slot;
a support step between the first side rail and the second side rail;
a first step frame comprising a step, the first step frame having a first end configured to reversibly slide and pivot in the first and second slots between the first side rail and the second side rail; and
a second step frame comprising a step, the second step frame having a first end attached to a second end of the first step frame and configured to reversibly pivot.

15. The storable ladder of claim 14, wherein:
the first step frame further comprises a first step side rail, a second step side rail, and a stop at the second end of the first step frame, wherein the step is between the first step side rail and the second step side rail; and
the second step frame further comprises a first step side rail and a second step side rail, wherein the step is between the first step side rail and the second step side rail.

16. The storable ladder of claim 15, wherein the first step frame further comprises a pivot handle adjacent to the stop.

17. The storable ladder of claim 14, wherein the first step frame further comprises a handle attached to the step and facing towards the second end of the first step frame.

18. The storable ladder of claim 14, wherein the first side rail further comprises a first flange perpendicular to the first sheet, wherein the second side rail further comprises a second flange perpendicular to the second sheet.

19. The storable ladder of claim 18, wherein the first flange and the second flange are configured to attach to a trailer or truck.

20. The storable ladder of claim 18, wherein the first slot is angled relative to the first flange such that a second end of the first slot is spaced a greater distance from the first flange than a first end of the slot.

21. The storable ladder of claim 14, further comprising a first handlebar reversibly secured to the first side rail and a second handlebar reversibly secured to the second side rail.

22. The storable ladder of claim 21, wherein the first handlebar is configured to be stored in a first sheath coupled to the first side rail, and wherein the second handlebar is configured to be stored in a second sheath coupled to the second side rail.

23. A kit comprising:
the storable ladder of claim 21;
a first cuff configured to hold the first handlebar; and
a second cuff configured to hold the second handlebar.
